(19) United States
(12) Patent Application Publication
(10) Pub. No.: US 2023/0210098 A1
(43) Pub. Date: Jul. 6, 2023

(54) FISHING APPARATUS HAVING CONSTRUCTION FOR ACCOMODATING A SCENT ATTRACTANT AND SYSTEM THEREFOR

(71) Applicant: Blake Lee Phillips, Dothan, AL (US)

(72) Inventor: Blake Lee Phillips, Dothan, AL (US)

(21) Appl. No.: 17/946,031

(22) Filed: Sep. 15, 2022

Related U.S. Application Data
(60) Provisional application No. 63/261,225, filed on Sep. 15, 2021.

(51) Int. Cl. A01K 85/01; A01K 85/00

(52) U.S. Cl. CPC A01K 85/018; A01K 85/1837; A01K 85/1847; A01K 95/00

(57) ABSTRACT

The present invention relates to fishing products, including weights and jigs, that comprise a novel configuration to accommodate fish scent attractant. The invention further comprises the combination of the fishing products and a fish scent attractant.

### BACKGROUND OF THE INVENTION

The present invention relates to types of fishing products, including weights and jigs, having a configuration to accommodate fish scent attractant and said fishing products combined with fish scent attractants.

A person fishing will often us a fish scent attractant to attract fish near the hook. As used herein a fish scent attractant is directed to a dissolvable solid or semi-solid olfactory fish-attractant refers to a product that contains at least one fish-attractant material that may include either or both of one or more substances to attract a fish to the area of the lure or baited hook or to stimulate a fish to bite the lure or the baited hook. The invention is usable in a variety of shapes, sizes, colors and configurations. The fish scent attractant is typically applied to a hook of a fishing lure to attract fish. The fishing scent attractant, however, is often a soft material often in a pellet-like form that may slowly dissolve in the water and does not stay on the hook for long and must be reapplied frequently.

The fishing scent attractant should be near the hook to attract the fish to the hook. Currently, there is no other appropriate place near the hook to place the fishing scent attractant, such as the fishing weight or the jig, to prevent the need to frequently reapply the attractant.

As can be seen, there is a need for a way to maintain a fish scent attractant near the hook so that it will be affixed in a way that will attract fish and reduce the need to reapply the fish scent attractant. One embodiment of the present invention provides a construction that allows for the attractant to affixed near the hook to attract fish without continual reapplication. The construction comprises a receptacle for accommodating an attractant material, so that the attractant material will be useful for many fishing casts before reapplication of the attractant. The present invention further comprises a receptacle for accommodating the attractant material wherein the receptacle is located in a fishing weight that can be attached to a fishing line and located near the hook, or in a jig construction portion of a fishing lure. The receptacle may be a a hole, or an opening, formed in the weight or the jig construction, so that the construction of the lure is designed to function as a fishing lure, as well as a fish scent attractant. The present invention further comprises a system comprising a combination of a jig fishing lure having a receptacle for receiving an attractant and an attractant positioned in the receptacle, wherein the receptacle is at a location near to the hook so that the attractant attracts fish to the lure. If the receptacle is positioned on the fishing weight, the weight is attached to the fishing line and slid to a position near the lure to attract fish.

### SUMMARY OF THE INVENTION

The present invention comprises a

### BRIEF DESCRIPTION OF THE DRAWINGS

FIG. 1 is a perspective view of a fishing weight according to an embodiment of the present invention;

FIG. 2 is another perspective view thereof;

FIG. 3 is a sectional view thereof;

FIG. 4 is a side view thereof;

FIG. 5 is another perspective view thereof; and

FIG. 6 is another perspective view thereof.

FIG. 7 is an overview of a fish scent attractant pellet.

FIG. 8 is a jig according to an embodiment of the present invention.

FIG. 9 is a jig according to the embodiment of the present invention.

FIG. 10 is a jig and fish scent attractant system according to an embodiment of the present invention.

### DETAILED DESCRIPTION OF THE INVENTION

The following detailed description comprises different embodiments of the present invention. The description is not to be taken in any limiting sense but is made merely for the purpose of illustration of the invention.

Broadly, an embodiment of the present invention provides a fishing weight with a compartment adapted to retain fishing attractant.

The inventive fishing weight may be molded by producing a mold with the shape of a weight with a hole. The shape of the weight is not particularly limited, provided that it has a cavity for attractant. The manufacturer may then pour lead in the mold.

A jig comprises a sinker and an elongated portion having a hook molded into the sinker, an eyelet attached to the sinker capable of receiving fishing line. In one embodiment, the jig comprises a first end an a second end, wherein the hook is located at said second end of said jig and the sinker is located at said first end of said jig. A jig may be covered by a soft body or other features to attract fish. Jigs may create a jerky, vertical motion as they move through the water. Jigs are very versatile and can be used for fishing in both salt and fresh water. Many species of fish are attracted to jigs, which has made jigs popular among sport fishers for many years.

A fishing weight, which also may be referred to as a sinker or knoch, is a weight used in conjunction with a fishing lure or hook to adjust its rate of sink, typically to increase its rate of sink, anchoring ability, and/or casting distance. Fishing sinkers may be as small as 1 gram for applications in shallow water, and even smaller for fly fishing applications, or as large as several pounds or considerably more for deep sea fishing. They are formed into nearly innumerable shapes for diverse fishing applications.

An ideal material for a fishing sinker is inexpensive and dense. Lead is often used, however, other materials, including but not limited to steel, brass, and bismuth, tungsten, different types of polymer composites, and the like, sinkers may be used have also been developed, using sand as weight.

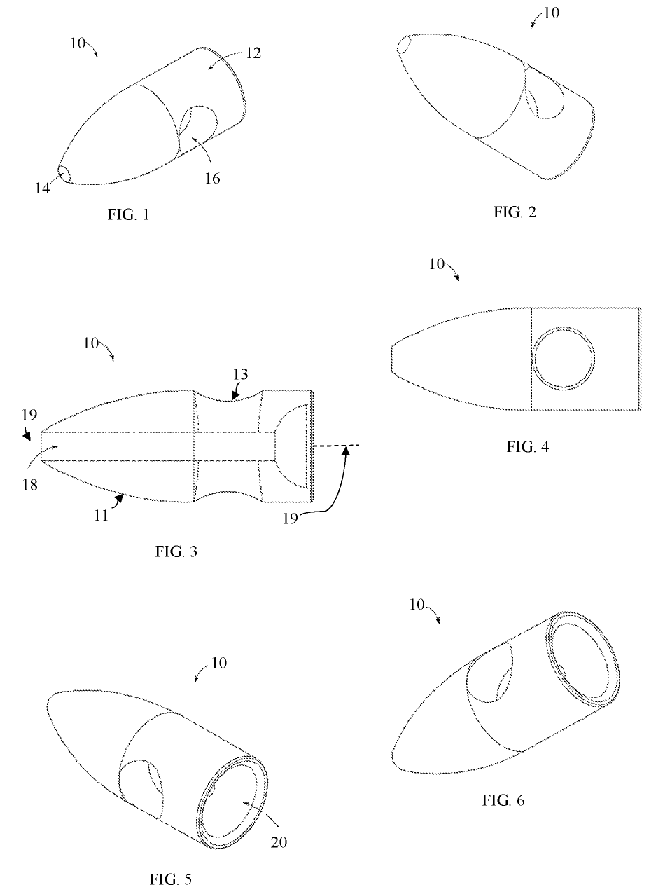

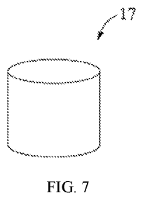

Referring now to FIGS. 1 through 6, a fishing weight 10 according to an embodiment of the present invention is shown. FIG. 1 shows the fishing weight 10 having a generally bullet shape, with a cylindrical portion 12 tapering to a nose 14. The weight 10 has a cavity 16, also herein referred to as a receptacle, extending laterally across the cylindrical portion 12, that is capable of accommodating a fish scent attractant. As best shown in FIG. 3, a cylindrical cavity 18 may extend along the longitudinal axis of the weight 10. Opposite the nose 14, the weight has a concave indentation 20, as shown in FIG. 5. FIG. 3 illustrates the fishing line 19 bisecting the weight as typical of a fishing weight. FIG. 7 illustrates a pellet form of a fishing scent attractant. The pellet 17, is places in receptacle 16 of FIG. 1 and will abut against the fishing line. The receptacle can be of any shape, cavity, indentation or the like in weight 10 that will receive and retain a fish scent attractant. For example, in FIGS. 1 through 6, the receptacle 18 extends the entire width of the weight 10 forming a first opening and a second opening in the fishing weigh or the sinker of the jig, however, the weight 10 may be formed such that the fish scent attractant is a soft or mailable material that may stay attached to the weight with the a lip at the edge of cavity 16 or other form of retaining the fish scent attractant material in, or attached to, the weight 10, including but not limited to a rough surface on the inner portion of cavity 16 (also herein referred to as a receptacle) that adheres to the fish scent material to prevent the need to continually reapply the fish scent attractant. The fish scent attractant is often a soft malleable material that can be compressed and forced into the receptacle. The fish scent material will then expand inside the cavity 16, receptacle, and be securely held in the weight. The receptacle can be any shape having an opening of at least 1 mm in height and 1 mm in width or if circular, 1 mm in diameter. The receptacle may be an indentation in the construction of the weight or sinker portion of the jig. The jig 10 has an outer surface 11 and wherein the indentation is at least 2 mm perpendicular to the surface 11 at its deepest point 13 (FIG. 3). The surface of the fishing weight or sinker may be treated, contoured or altered in other way to improve the attachment of the fish scent attractant to the fishing weight or sinker. The receptacle in the present invention can of any size or shape, depending on the size of the sinker or fishing weight. Different size fishing weights and jigs are used for different types of fishing, resulting in different types, shapes and sizes of fishing scent attractants. The receptacle in the present invention is of a size, depth and opening, to accommodate the fishing scent attractant and retain a functional fishing scent attractant. For example, the opening should be at least 1 mm in width and 1 mm in height and have a depth of at least 1 mm or the width of the sinker. For example, some jig sinkers may be 1 mm or less in width. If the sinker or fishing weight have a opening on either side of the sinker or fishing weight, the depth can be the width of the sinker or fishing weight. The depth of the receptacle is considered with the receptacle does not extend the width of the fishing weight or jig. The receptacle should be a sufficient size and depth to retain a fishing scent attractant material. The opening can extend the width of the fishing weight or sinker, or any distance in between, including 3 mm, 4 mm and at least up to and above 5 cm for certain fishing applications.

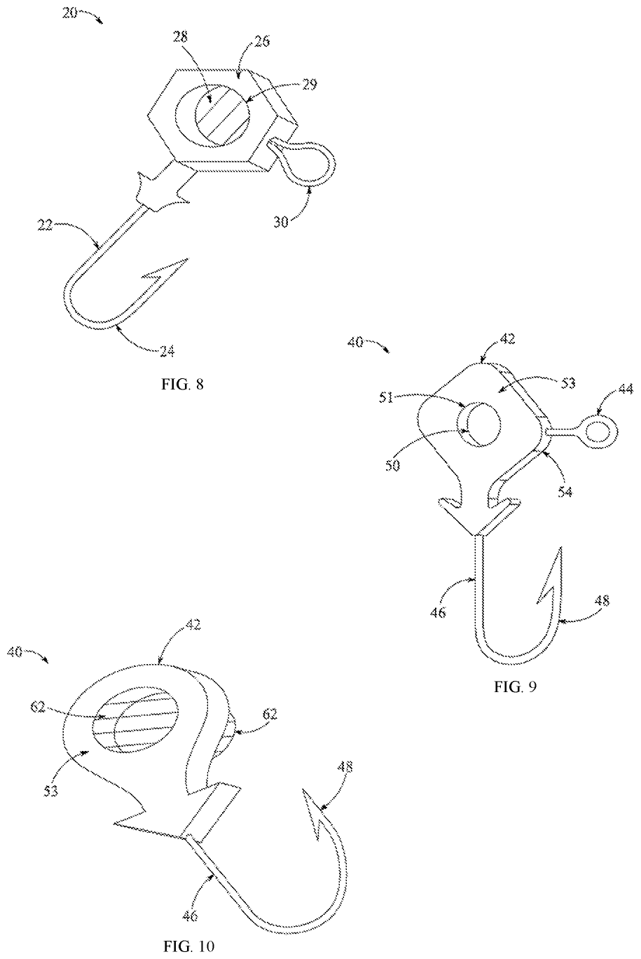

FIG. 8 illustrates an embodiment of the present invention comprising a sinker 26 and an elongated portion 22 having a hook molded into the sinker 24, an eyelet 30 attached to the sinker 26 capable of receiving fishing line, wherein the sinker portion of the jig is shaped so as to receive a fish scent attractant 17. The receptacle 28 is formed in the sinker 26, to receive the fish scent attractant material 17. The receptacle in FIG. 8 is an indentation having inner portion 29 that is part of the sinker 26. The receptacle in FIG. 8 is circular, however, it may be any shape that is capable of retaining a fish scent attractant. The receptacle 28 in FIG. 8, does not penetrate entirely through the sinker 26, but rather has an inner portion 29. The receptacle can go all the way through the sinker 26. In FIG. 9, sinker portion 42 is constructed to in a circular or oval form having a receptacle 50 having an inner portion 51, an outer portion 53 and a side portion 54. In this embodiment a fish scent attractant, such as the one illustrated in FIG. 7, 17, the fish scent attractant is compressed and slid into receptacle 50 so that the fish scent attractant 17 contacts the inner portion 51 and expands causing the fish scent attractant to be retained by the jig 40 until the fish scent attractant sufficiently degrades or dissolves to be no longer useful as an attractant.

FIG. 10 illustrates the jig 40 having a fish scent attractant 62 retained within the receptacle 50 and extending through the sinker 42. The combination illustrated in FIG. 10 has been tested experimentally and has shown that the fish scent attractant is retained in the jig near the hook for significantly longer that when the fish scent attractant is attached to the hook. In addition, experimental testing has illustrated that the jig 40 and fish scent attractant 62 combination increases the likelihood of catching fish.

It should be understood, of course, that the foregoing relates to exemplary embodiments of the invention and that modifications may be made without departing from the spirit and scope of the invention as set forth in the following claims.

What is claimed is:

1. A jig comprising:
a. an elongated substantially rigid body having a first end and a second end, wherein said second end comprises an elongated hook shank;
b. a sinker attached to said fist end of said elongated substantially rigid body, and wherein said sinker further comprises an eyelet; wherein the sinker has a construction that comprises a first opening and a second opening, wherein said first opening and said second opening are connected and wherein said opening is at least 1 mm in width and 1 mm in height.

2. A jig comprising:
a. an elongated substantially rigid body having a first end and a second end, wherein said second end comprises an elongated hook shank;
b. a sinker attached to said fist end of said elongated substantially rigid body, and wherein said sinker further comprises an eyelet; wherein the sinker has a construction that comprises an indentation in the construction of at least 2 mm and an opening at least 1 mm in width and 1 mm in height.

3. A jig comprising:
a. an elongated substantially rigid body having a first end and a second end, wherein said second end comprises an elongated hook shank;
b. a sinker attached to said fist end of said elongated substantially rigid body, and wherein said sinker further comprises an eyelet; wherein the sinker has a construction that comprises a receptacle for retaining a fishing scent attractant.

4. A fishing weight comprising:
a. a substantially rigid body having a surface and comprises a means for attaching to a fishing line;
b. wherein the surface of said substantially rigid body has a construction that comprises a first opening and a second opening, wherein said first opening and said second opening are connected and wherein said opening is at least 1 mm in width and 1 mm in height.

5. A fishing weight comprising:
a. a substantially rigid body having a surface and comprises a means for attaching to a fishing line;
b. wherein the surface of said substantially rigid body has a construction that comprises an indentation in the construction of at least 2 mm and an opening at least 1 mm in width and 1 mm in height.

6. A fishing weight comprising:
a substantially rigid body having a surface and comprises a means for attaching to a fishing line; wherein the substantially rigid body has a construction that comprises a receptacle for retaining a fishing scent attractant.

7. A jig comprising:
a. an elongated substantially rigid body having a first end and a second end, wherein said second end comprises an elongated hook shank;
b. a sinker attached to said fist end of said elongated substantially rigid body, and wherein said sinker further comprises an eyelet; wherein the sinker has a construction that comprises a receptacle; and
c. a fishing scent attractant affixed to the sinker.

8. A fishing weight comprising:
a substantially rigid body having a surface and comprises a means for attaching to a fishing line; wherein the substantially rigid body has a construction that comprises a receptacle and a fishing scent attractant affixed to the receptacle.
